(19) United States
(12) Patent Application Publication
(10) Pub. No.: US 2026/0095787 A1
(43) Pub. Date: Apr. 2, 2026

(54) SECONDARY CELL ACTIVATION STATUS REPORTING

(71) Applicant: QUALCOMM Incorporated, San Diego, CA (US)

(72) Inventors: Jae Ho RYU, San Diego, CA (US); Heechoon LEE, San Diego, CA (US); Yi HUANG, San Diego, CA (US); Hari SANKAR, San Diego, CA (US)

(21) Appl. No.: 18/900,498

(22) Filed: Sep. 27, 2024

(51) Int. Cl. H04W 24/10; H04W 72/1268

(52) U.S. Cl. CPC H04W 24/10; H04W 72/1268

(57) ABSTRACT

Methods, systems, and devices for wireless communications are described. A user equipment (UE) supporting carrier aggregation may receive an indicator of an activation of one or more secondary cells configured for the UE. Responsive to the activation indication, the UE may perform at least a portion of a synchronization procedure, one or more channel state information (CSI) measurements, or both, for the one or more secondary cells. After completion of the synchronization procedure, the one or more CSI measurements, or both, the UE may transmit, via an uplink control information (UCI) message, a status indication for the one or more secondary cells that indicates the completion of the synchronization procedure, the one or more CSI measurements, or both. The UE may then receive a message that requests aperiodic CSI reporting from the UE of the one or more secondary cells responsive to the status indication.

### FIELD OF TECHNOLOGY

The following relates to wireless communications, including secondary cell activation status reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indicator of an activation of one or more secondary cells configured for the UE, performing at least a portion of a synchronization procedure, one or more channel state information (CSI) measurements, or both, for the one or more secondary cells in accordance with the activation of the one or more secondary cells, transmitting, via an uplink control information (UCI) message, a status indication for the one or more secondary cells that indicates completion of the synchronization procedure, the one or more CSI measurements, or both, and receiving a message that requests aperiodic CSI reporting from the UE of the one or more secondary cells based on transmission of the status indication.

A UE for wireless communications is described. The UE may include one or more memories storing processor executable code, and one or more processors coupled with the one or more memories. The one or more processors may individually or collectively be operable to execute the code to cause the UE to receive an indicator of an activation of one or more secondary cells configured for the UE, perform at least a portion of a synchronization procedure, one or more CSI measurements, or both, for the one or more secondary cells in accordance with the activation of the one or more secondary cells, transmit, via a UCI message, a status indication for the one or more secondary cells that indicates completion of the synchronization procedure, the one or more CSI measurements, or both, and receive a message that requests aperiodic CSI reporting from the UE of the one or more secondary cells based on transmission of the status indication.

Another UE for wireless communications is described. The UE may include means for receiving an indicator of an activation of one or more secondary cells configured for the UE, means for performing at least a portion of a synchronization procedure, one or more CSI measurements, or both, for the one or more secondary cells in accordance with the activation of the one or more secondary cells, means for transmitting, via a UCI message, a status indication for the one or more secondary cells that indicates completion of the synchronization procedure, the one or more CSI measurements, or both, and means for receiving a message that requests aperiodic CSI reporting from the UE of the one or more secondary cells based on transmission of the status indication.

A non-transitory computer-readable medium storing code for wireless communications is described. The code may include instructions executable by one or more processors to receive an indicator of an activation of one or more secondary cells configured for the UE, perform at least a portion of a synchronization procedure, one or more CSI measurements, or both, for the one or more secondary cells in accordance with the activation of the one or more secondary cells, transmit, via a UCI message, a status indication for the one or more secondary cells that indicates completion of the synchronization procedure, the one or more CSI measurements, or both, and receive a message that requests aperiodic CSI reporting from the UE of the one or more secondary cells based on transmission of the status indication.

Some examples of the method, UEs, and non-transitory computer-readable medium described herein may further include operations, features, means, or instructions for receiving control signaling indicative of a configuration of a set of periodic channel measurement resources, a set of periodic interference measurement resources, or both, where performing at least the portion of the synchronization procedure, the one or more CSI measurements, or both, includes, performing the synchronization procedure, and performing, subsequent to the completion of the synchronization procedure and prior to transmission of the UCI message, the one or more CSI measurements using a periodic channel measurement resource of the set of periodic channel measurement resources or a periodic interference measurement resource of the set of periodic interference measurement resources.

In some examples of the method, UEs, and non-transitory computer-readable medium described herein, performing at least the portion of the synchronization procedure, the one or more CSI measurements, or both may include operations, features, means, or instructions for performing the synchronization procedure and performing, subsequent to the completion of the synchronization procedure and subsequent to transmission of the UCI message, the one or more CSI measurements using an aperiodic channel measurement resource indicated by the message that requests the aperiodic CSI reporting, or using an aperiodic interference measurement resource indicated by the message that requests the aperiodic CSI reporting.

Some examples of the method, UEs, and non-transitory computer-readable medium described herein may further include operations, features, means, or instructions for receiving control signaling indicative of a configuration of the one or more secondary cells, a set of aperiodic or periodic channel measurement resources, a set of aperiodic or periodic interference measurement resources, or any combination thereof, where transmitting the status indication includes and transmitting the status indication subsequent to the performing the synchronization procedure and prior to performing the one or more CSI measurements, or subsequent to performing both the synchronization procedure and the one or more CSI measurements, based on the control signaling.

In some examples of the method, UEs, and non-transitory computer-readable medium described herein, transmitting the status indication for the one or more secondary cells may include operations, features, means, or instructions for transmitting, via the UCI message, a single bit that indicates completion of the synchronization procedure, the one or more CSI measurements, or both, for all of the one or more secondary cells.

In some examples of the method, UEs, and non-transitory computer-readable medium described herein, the single bit includes a group common indication associated with the one or more secondary cells.

In some examples of the method, UEs, and non-transitory computer-readable medium described herein, transmitting the status indication for the one or more secondary cells may include operations, features, means, or instructions for transmitting, via the UCI message, a set of one or more bits that indicates completion of the synchronization procedure, the one or more CSI measurements, or both, for at least one secondary cell group of the one or more secondary cell groups, where each secondary cell group corresponds to a single bit of the set of one or more bits.

Some examples of the method, UEs, and non-transitory computer-readable medium described herein may further include operations, features, means, or instructions for receiving a control message indicative of respective cell group identifiers for the one or more secondary cells that correspond to a respective secondary cell group of the one or more secondary cell groups, where the respective cell group identifiers map to respective bits of the set of one or more bits of the UCI message.

In some examples of the method, UEs, and non-transitory computer-readable medium described herein, secondary cells operating on a same frequency band may be included in a same secondary cell group of the one or more secondary cell groups.

In some examples of the method, UEs, and non-transitory computer-readable medium described herein, transmitting the status indication for the one or more secondary cells may include operations, features, means, or instructions for transmitting, via the UCI message, a set of one or more bits that indicates completion of the synchronization procedure, the one or more CSI measurements, or both, for at least one secondary cell of the one or more secondary cells, where each secondary cell corresponds to a single bit of the set of one or more bits.

Some examples of the method, UEs, and non-transitory computer-readable medium described herein may further include operations, features, means, or instructions for receiving a control message indicative of respective cell indices that correspond to respective secondary cells of the one or more secondary cells, where the respective cell indices map to respective bits of the set of one or more bits of the UCI message.

In some examples of the method, UEs, and non-transitory computer-readable medium described herein, transmitting the status indication may include operations, features, means, or instructions for transmitting the status indication via an uplink control channel resource that may be dedicated for transmission of the UCI message conveying the status indication.

In some examples of the method, UEs, and non-transitory computer-readable medium described herein, transmitting the status indication may include operations, features, means, or instructions for transmitting the status indication via an uplink control channel resource of a set of multiple uplink control channel resources that may be configured for either transmissions of the UCI message conveying the status indication or for other UCI messages.

In some examples of the method, UEs, and non-transitory computer-readable medium described herein, transmitting the status indication may include operations, features, means, or instructions for multiplexing the status indication with other UCI in the UCI message.

Some examples of the method, UEs, and non-transitory computer-readable medium described herein may further include operations, features, means, or instructions for receiving control signaling including an uplink control channel resource indicator that indicates the uplink control channel resource from the set of multiple uplink control channel resources to use for transmission of the UCI message conveying the status indication.

In some examples of the method, UEs, and non-transitory computer-readable medium described herein, the control signaling includes a radio resource control (RRC) message that configures the one or more secondary cells or a medium access control-control element (MAC-CE) that activates the one or more secondary cells.

In some examples of the method, UEs, and non-transitory computer-readable medium described herein, transmitting the status indication may include operations, features, means, or instructions for transmitting the status indication via an uplink control channel resource of a set of multiple uplink control channel resources that may be valid for transmission of the status indication for a time window that spans a threshold duration.

In some examples of the method, UEs, and non-transitory computer-readable medium described herein, the threshold duration begins after a threshold secondary cell activation delay elapses and ends subsequent to receiving the message that requests the aperiodic CSI reporting.

In some examples of the method, UEs, and non-transitory computer-readable medium described herein, transmitting the status indication may include operations, features, means, or instructions for dropping one or more other UCI messages that lack the status indication within the time window and transmitting the UCI message conveying the status indication via the uplink control channel resource based on dropping the one or more other UCI messages.

In some examples of the method, UEs, and non-transitory computer-readable medium described herein, transmitting the status indication may include operations, features, means, or instructions for multiplexing the UCI message conveying the status indication with one or more other UCI messages on the uplink control channel resource.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support secondary cell activation status reporting in accordance with one or more aspects of the present disclosure.

FIG. 3 shows example secondary cell activation reporting timing diagrams that supports secondary cell activation status reporting in accordance with one or more aspects of the present disclosure.

FIGS. 4 and 5 show example uplink resource reporting configurations that support secondary cell activation status reporting in accordance with one or more aspects of the present disclosure.

FIG. 6 shows an example of a secondary cell activation reporting timing diagram that supports secondary cell activation status reporting in accordance with one or more aspects of the present disclosure.

FIG. 7 shows an example of a process flow that supports secondary cell activation status reporting in accordance with one or more aspects of the present disclosure.

FIGS. 8 and 9 show block diagrams of devices that support secondary cell activation status reporting in accordance with one or more aspects of the present disclosure.

FIG. 10 shows a block diagram of a communications manager that supports secondary cell activation status reporting in accordance with one or more aspects of the present disclosure.

FIG. 11 shows a diagram of a system including a device that supports secondary cell activation status reporting in accordance with one or more aspects of the present disclosure.

FIGS. 12 through 14 show flowcharts illustrating methods that support secondary cell activation status reporting in accordance with one or more aspects of the present disclosure.

### DETAILED DESCRIPTION

In some wireless communications systems, devices such as a user equipment (UE) may support carrier aggregation to increase data rate, cell coverage, and overall device performance. In some cases, the network entity may aggregate two or more portions of a radio frequency spectrum including a primary component carrier, associated with a primary cell, and one or more secondary component carriers associated with one or more secondary cells. In some aspects, the network entity may establish or activate the one or more secondary cells in cases where the UE may benefit from higher throughput (e.g., increased downlink data throughput), increased coverage, improved service quality, higher bitrates, among other services.

In some examples, the network entity may activate (and deactivate) secondary cells at the UE based on different operating scenarios, communications quality, downlink throughput, or other performance metrics. During secondary cell activation, the network entity may transmit an activation trigger message via a medium access control-control element (MAC-CE), which prompts the UE to begin downlink synchronization and channel measurement (e.g., channel state information (CSI) measurement) in order to activate the secondary cell. In some examples, a synchronization procedure may include a process in which the network entity 105-b transmits a set of synchronization signal blocks (SSBs) to the UE 115-b, which may include synchronization signals (e.g., a primary synchronization signal (PSS) and a secondary synchronization signal (SSS)) and a physical broadcast channel (PBCH), that the UE 115-b may utilize to synchronize with the secondary cell and obtain configuration information associated with the secondary cell. In some examples, the UE 115-b may use the SSBs to identify timing resources, frequency resources, a cell identifier (ID), or perform beam acquisition for the one or more secondary cells. In some examples, the UE 115-b may perform a signal quality measurement on a synchronization signal of the SSBs, identify an automatic gain control (AGC) and time or frequency tracking loops based on the SSBs, may identify a root quasi co-located (QCL) source for signals or channels based on the SSBs, or any combination thereof. In some examples, the UE 115-b may receive SSBs periodically (e.g., in accordance with a periodicity) from one or more network nodes associated with the secondary cell. For example, a network node may transmit a burst of SSBs in a defined periodicity (e.g., every X milliseconds) so that the UE 115-b may monitor for and receive the SSBs periodically in order to perform downlink synchronization.

After a time duration that may account for delay in receiving and acquiring the synchronization signals and channel measurements (e.g., a worst-case delay), the network entity then sends a request for aperiodic CSI reporting by the UE, and in response, the UE sends a CSI report including the channel measurements for the secondary cell. Once the network entity receives the CSI report from the UE, the network entity may schedule communications on the secondary cell. In some cases, however, the delay between the activation of the secondary cell (e.g., transmission of the activation trigger MAC-CE) and actual scheduling on the secondary cell may be substantial. For example, the UE may complete downlink synchronization and CSI reporting and may wait for some time before receiving the aperiodic CSI reporting request from the network. Such inefficiencies in the activation procedure for secondary cells may then increase scheduling and communications latency on the secondary cell.

To support efficient secondary cell activation and measurement reporting, the UE may transmit an indication that the UE is ready for CSI reporting for the secondary cell, or otherwise that measurements for the secondary cell are ready to be reported. In some implementations, the UE may transmit the indication immediately after performing downlink synchronization and CSI measurement (if CSI measurement resources are periodic), and may receive the aperiodic CSI reporting trigger immediately (e.g., within a relatively short threshold duration) after transmitting the indication. In some other implementations, the UE may transmit the indication immediately after performing downlink synchronization (if CSI measurement resources are aperiodic), and may receive the aperiodic CSI reporting trigger immediately after transmitting the indication, where the CSI reporting trigger may include an indication of CSI measurement resources and resources to transmit the CSI report after the UE performs the CSI measurement. The UE may transmit a multi-bit indication or a single-bit indication based on the configuration of multiple secondary cells or secondary cell groups for the UE, where the bits indicate different grouping configurations for the multiple secondary cells (or individual secondary cells) which have been activated. In some examples, the UE may transmit the indication via a dedicated uplink channel resource, or may multiplex the indication with other forms of uplink control information (UCI).

Aspects of the disclosure may be implemented to realize one or more potential advantages. For example, transmission of the secondary cell activation status indication may reduce the overall time between activating a secondary cell and for communications to be scheduled and performed on the secondary cell. In some aspects, the reduced time between activation and scheduling of the secondary cell may reduce latency, increase throughput and data rates, and improve overall device performance. Additionally, or alternatively, the techniques described herein may support improved device coordination, where the UE may communicate with the network entity directly to notify the network entity of the availability of measurements for an activated secondary cell.

Aspects of the disclosure are initially described in the context of wireless communications systems. Aspects of the disclosure are further illustrated by and described with reference to secondary cell activation reporting timing diagrams, uplink resource reporting diagrams, a process flow, apparatus diagrams, system diagrams, and flowcharts that relate to secondary cell activation status reporting.

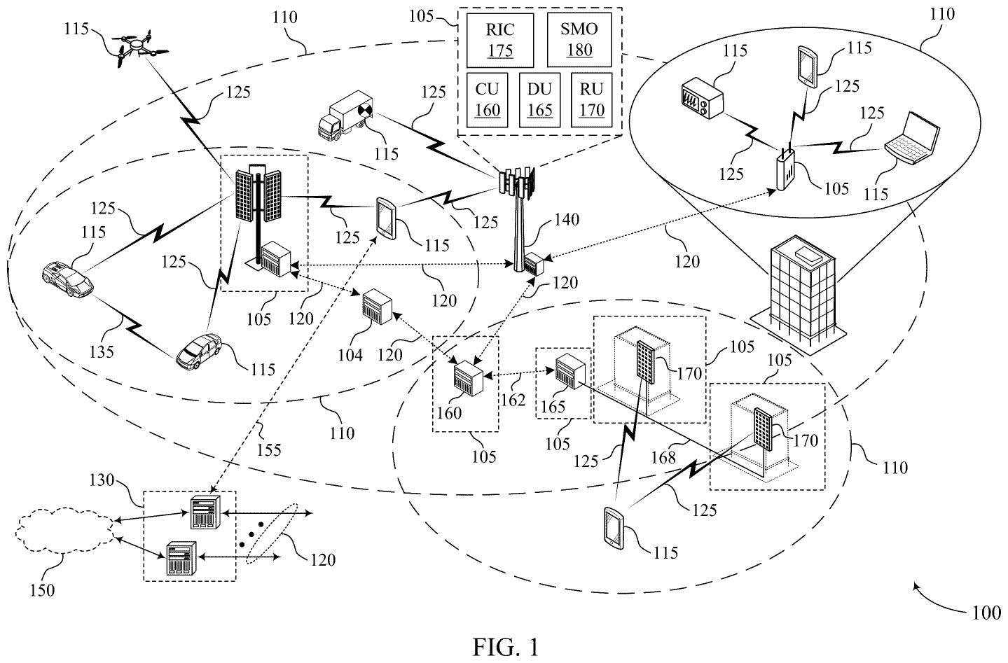

FIG. 1 shows an example of a wireless communications system 100 that supports secondary cell activation status reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support secondary cell activation status reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ˜N_{ƒ}) seconds, for which Δƒₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N₇₁) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a network entity 105 may activate (and deactivate) secondary cells at a UE 115 based on different operating scenarios, communications quality, downlink throughput, or other performance metrics. During secondary cell activation, the network entity 105 may transmit an activation trigger message via a MAC-CE which prompts the UE 115 to begin downlink synchronization and channel measurement (e.g., CSI) in order to activate the secondary cell. After some time, the network entity 105 transmits a request for aperiodic CSI reporting by the UE 115, and in response, the UE 115 sends a CSI report including the channel measurements for the secondary cell. Once the network entity receives the CSI report from the UE 115, the network entity 105 may schedule communications on the secondary cell. In some cases, however, there may be substantial delay between the activation of the secondary cell (e.g., transmission of the activation trigger MAC-CE) and actual scheduling on the secondary cell.

To support efficient secondary cell activation and measurement reporting, the UE 115 may be configured to transmit an indication that the UE 115 is ready for CSI reporting for the secondary cell. In some implementations, the UE 115 may transmit the indication immediately after performing downlink synchronization and CSI measurement (if CSI measurement resources are periodic), and may receive the aperiodic CSI reporting trigger immediately (e.g., within a relatively short threshold duration) after transmitting the indication. In some other implementations, the UE 115 may transmit the indication immediately after performing downlink synchronization (if CSI measurement resources are aperiodic), and may receive the aperiodic CSI reporting trigger immediately after transmitting the indication, where the CSI reporting trigger may include an indication of CSI measurement resources and resources to transmit the CSI report after the UE 115 performs the CSI measurement.

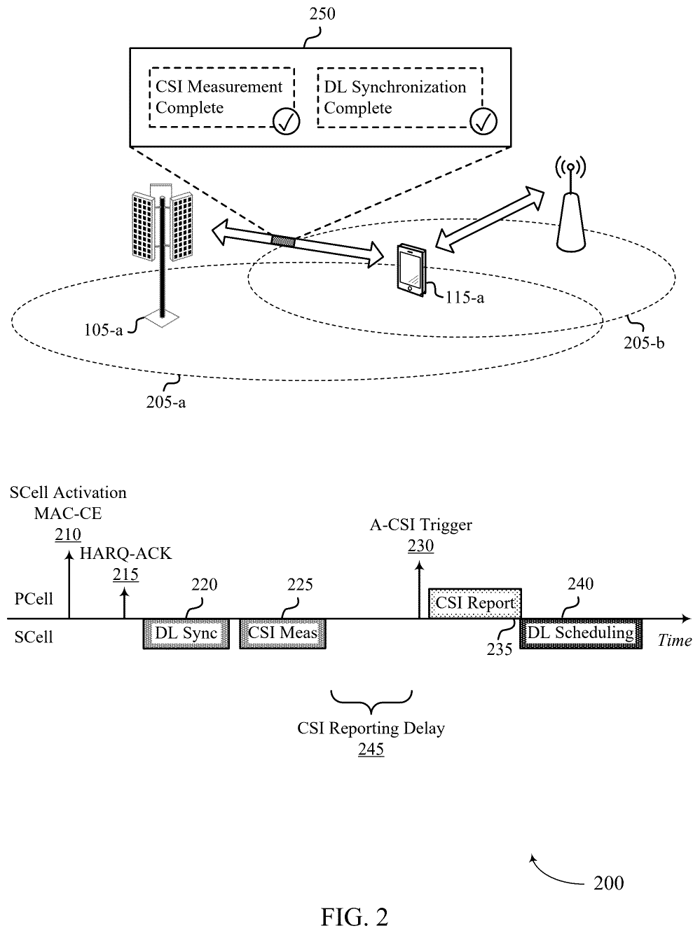

FIG. 2 shows an example of a wireless communications system 200 that supports secondary cell activation status reporting in accordance with one or more aspects of the present disclosure. For example, the wireless communications system 200 may support communications between a UE 115-a and a network entity 105-a, each of which may be examples of corresponding UEs 115 and network entities 105 described herein.

The UE 115-a may support carrier aggregation to increase data rate, cell coverage, and overall device performance. In some cases, the network entity 105-a may aggregate two or more portions of a radio frequency spectrum including a primary component carrier (PCC) and one or more secondary component carriers (SCC). The cell serving the PCC may be referred to as a primary cell 205-a, and the cell serving the one or more SCCs may be referred to as a secondary cell 205-b. The network entity 105-a may establish a primary cell 205-a and one or more secondary cells (including at least the secondary cell 205-b) for use by the UE 115-a based on measurement reporting (e.g., layer-3 measurement reporting, including beam level measurements, cell level measurements, or both) received from the UE 115-a. For example, in cases where the UE 115-a may benefit from higher throughput (e.g., increased downlink data throughput), increased coverage, improved service quality, higher bitrates, among other services, the network entity 105-a may establish one or more secondary cells for the UE 115-a to utilize for communications.

In some examples, the network entity 105-a may activate (and deactivate) secondary cells at the UE 115-a based on different operating scenarios, communications quality, downlink throughput, or other performance metrics. For example, if the network entity 105-a identifies a need for additional downlink throughput, the network entity 105-a may activate one or more secondary cells at the UE 115-a. Additionally, or alternatively, the network entity 105-a may perform load balancing for the primary cell 205-a by activating the secondary cell 205-b for the UE 115-a.

To initiate secondary cell activation, the network entity 105-a may transmit a secondary cell activation command 210 (e.g., a secondary cell activation trigger, a secondary cell activation instruction message) via control signaling (e.g., MAC-CE) to the UE 115-a. After receiving the secondary cell activation message, the UE 115-a may transmit a HARQ-ACK feedback message 215 and perform downlink synchronization 220 for the secondary cell 205-b. The UE 115-a may then perform CSI measurements 225 on the secondary cell 205-b in order to support scheduled communications on the secondary cell 205-b. The network entity 105-a may then transmit an aperiodic CSI trigger 230 which requests a CSI report from the UE 115-a including the CSI measurements 225 for the secondary cell 205-b. The UE 115-a may transmit a CSI report 235 including the CSI measurements to the network entity 105-a, and the network entity 105-a may use the CSI measurements to accurately schedule downlink communications (e.g., PDCCH communications, PDSCH communications, a downlink data burst) for the UE 115-a on the secondary cell 205-b. In some implementations, the network entity 105-a may deactivate the secondary cell 205-b after completion of the scheduled downlink communications and may reactivate the secondary cell 205-b as additional scheduled downlink communications become available. Additionally, or alternatively, the network entity 105-a may keep the secondary cell 205-b activated for a duration of time before deactivating the secondary cell (e.g., the network entity 105-a may keep the secondary cell 205-b activated if multiple downlink traffic bursts are scheduled for the UE 115-a, or during other times of high traffic).

In some cases, however, the UE 115-a may complete downlink synchronization 220, CSI measurements 225, or both, before the network entity 105-a transmits the aperiodic CSI trigger 230, which may introduce excess latency associated with the CSI reporting delay 245. For example, the delay between a time that the UE 115-a receives the secondary cell activation command 210 (e.g., the downlink MAC-CE) and a time that the UE 115-a receives a downlink scheduling 240 for the secondary cell 205-b may be very large based on the CSI reporting delay 245. Such delays may reduce service quality for different traffic types or traffic patterns (e.g., video traffic, streaming services, or other bursty traffic types) since the data delivery on the primary cell 205-a may be already complete or almost complete by the time the secondary cell 205-b is ready to be scheduled with downlink data.

In some aspects, the CSI reporting delay 245 that occurs during secondary cell activation may be based on various different factors, including downlink synchronization delay, CSI measurement delay, CSI reporting delay, a time in which the network entity 105-a waits to transmit the aperiodic CSI trigger 230, among other possible delays. In some examples, the downlink synchronization delay may be variable based on secondary cell measurement history prior to the UE 115-a receiving the secondary cell activation command 210 (e.g., the downlink synchronization delay may be relatively less if the UE 115-a has recently measured the secondary cell). In some examples, the CSI measurement delay may be variable based on the availability of CSI measurement resources for the UE 115-a to use to perform the CSI measurements. For example, the UE 115-a may wait for up to 20 milliseconds to obtain a periodic channel measurement resource or interference measurement resource to use to perform the CSI measurements in addition to up to two millisecond delay for performing the measurements (e.g., depending on the complexity of the CSI measurements). In some examples, the CSI reporting delay may be based on a periodicity of periodic CSI reporting (e.g., 20 milliseconds, 40 milliseconds), or may be based on scheduling performed by the network entity 105-a for aperiodic CSI reporting and transmission of the aperiodic CSI trigger 230. For example, in some cases, the network entity 105-a may wait for a substantial duration of time before transmitting the aperiodic CSI trigger 230, which may exceed the amount of time that the UE 115-a uses to perform downlink synchronization and CSI measurement, resulting in increased latency for secondary cell activation.

In order to reduce the latency incurred based on the CSI reporting delay 245 and to reduce the overall time for secondary cell activation, the UE 115-a may transmit an indication that CSI measurements for the secondary cell 205-b are ready to be reported. In some cases, the UE 115-a may transmit an indication 250 after performing downlink synchronization and CSI measurements (e.g., the CSI measurements may be performed using periodic channel measurement resources or interference measurement resources). The network entity 105-a may transmit the aperiodic CSI reporting trigger after receiving the indication 250. In some cases, the UE 115-a may transmit the indication 250 after performing downlink synchronization, and the network entity 105-a may transmit the aperiodic CSI reporting trigger along with an indication of aperiodic channel measurement resources or interference measurement resources to perform CSI measurements. The UE 115-a may transmit the CSI report after completion of the CSI measurements.

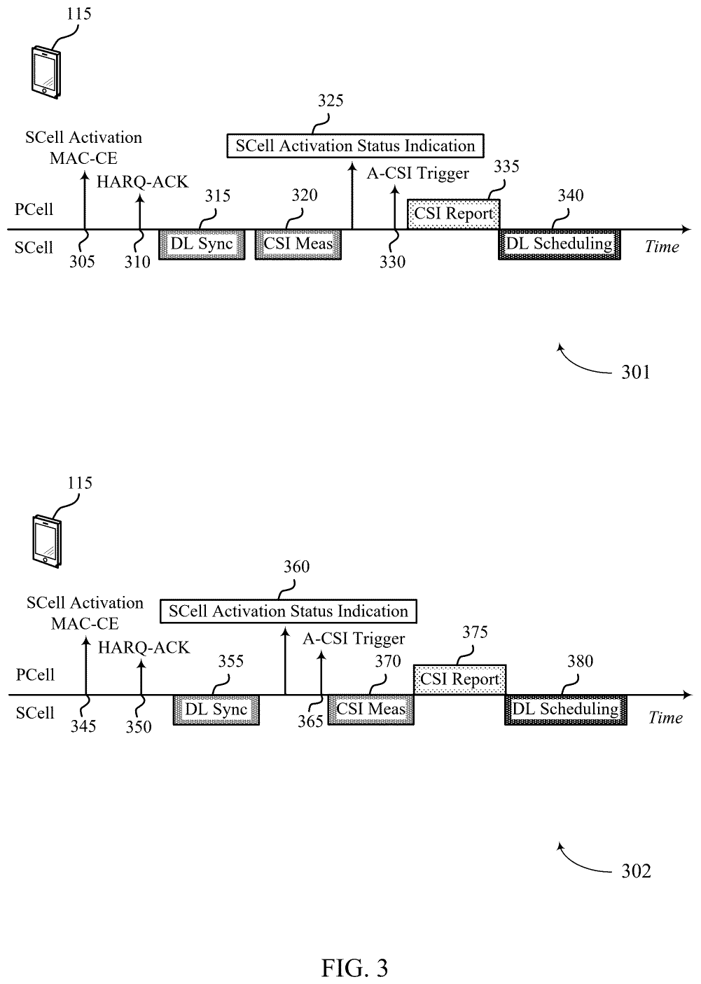

FIG. 3 shows example secondary cell activation reporting timing diagrams 301 and 302 that support secondary cell activation status reporting in accordance with one or more aspects of the present disclosure. For example, the secondary cell reporting timing diagrams 301 and 302 illustrate timelines for a UE 115 to report a secondary cell activation status indication to indicate activation of one or more secondary cells configured for the UE 115. In some aspects, the UE 115 may be an example of a UE 115 described with reference to FIGS. 1-5.

The secondary cell activation reporting timing diagram 301 illustrates a timeline for reporting a secondary cell activation status indication after performing both downlink synchronization and CSI measurements. A secondary cell activation procedure may be initiated when a network entity transmits a secondary cell activation MAC-CE 305 that activates one or more secondary cells for the UE 115. The UE 115 may transmit a HARQ-ACK feedback message 310 to acknowledge receipt of the secondary cell activation MAC-CE 305. The UE 115 may then perform downlink synchronization 315 for the one or more secondary cells, and may perform CSI measurements 320 using periodic resources (e.g., periodic channel measurement resources, periodic interference measurement resources). After performing downlink synchronization 315 and the CSI measurements 320, the UE 115 may transmit (e.g., via a PUCCH resource on the primary cell) the secondary cell activation status indication 325 to indicate the secondary cell activation. The UE 115 may receive an aperiodic CSI reporting trigger 330 that requests one or more CSI reports, and the UE 115 may transmit the CSI reports 335 to the network entity. After transmitting the CSI reports, the UE 115 may receive downlink scheduling 340 on the activated secondary cell.

The secondary cell activation reporting timing diagram 302 illustrates a timeline for reporting a secondary cell activation status indication after performing downlink synchronization and prior to performing CSI measurements. A secondary cell activation procedure may be initiated when a network entity transmits a secondary cell activation MAC-CE 345 that activates one or more secondary cells for the UE 115. The UE 115 may transmit a HARQ-ACK feedback message 350 to acknowledge receipt of the secondary cell activation MAC-CE 345. The UE 115 may then perform downlink synchronization 355 for the one or more secondary cells and may transmit (e.g., via a PUCCH resource on the primary cell) the secondary cell activation status indication 360 to indicate the secondary cell activation. The UE 115 may receive an aperiodic CSI reporting trigger 365 that requests one or more CSI reports and includes an indication of one or more aperiodic resources (e.g., aperiodic channel measurement resources, aperiodic interference measurement resource) that the UE 115 may use to perform CSI measurements for the one or more secondary cells. The UE 115 may perform CSI measurements 370 and may transmit one or more CSI reports 375 after completion of the CSI measurements. After transmitting the CSI reports, the UE 115 may receive downlink scheduling 380 on the activated secondary cell.

In some implementations, the UE 115 may perform secondary cell activation status transmission based on the secondary cell activation reporting timing diagram 301 or the secondary cell activation reporting timing diagram 302 based on explicit notification by a network entity (e.g., the network entity may notify the UE 115 via RRC signaling that configures the one or more secondary cells). Additionally, or alternatively, the UE 115 may implicitly determine to utilize the secondary cell activation status transmission based on the secondary cell activation reporting timing diagram 301 or the secondary cell activation reporting timing diagram 302 based on the configuration or presence of periodic measurement resources or aperiodic measurement resources on the one or more secondary cells. For example, the UE 115 may perform both downlink synchronization and CSI measurements prior to transmission of the secondary cell activation status indication based on the configuration of periodic measurement resources for the secondary cell. Alternatively, the UE 115 may perform downlink synchronization prior to transmission of the secondary cell activation status indication and may perform CSI measurement after transmission of the secondary cell activation status indication based on the configuration of aperiodic measurement resources for the secondary cell.

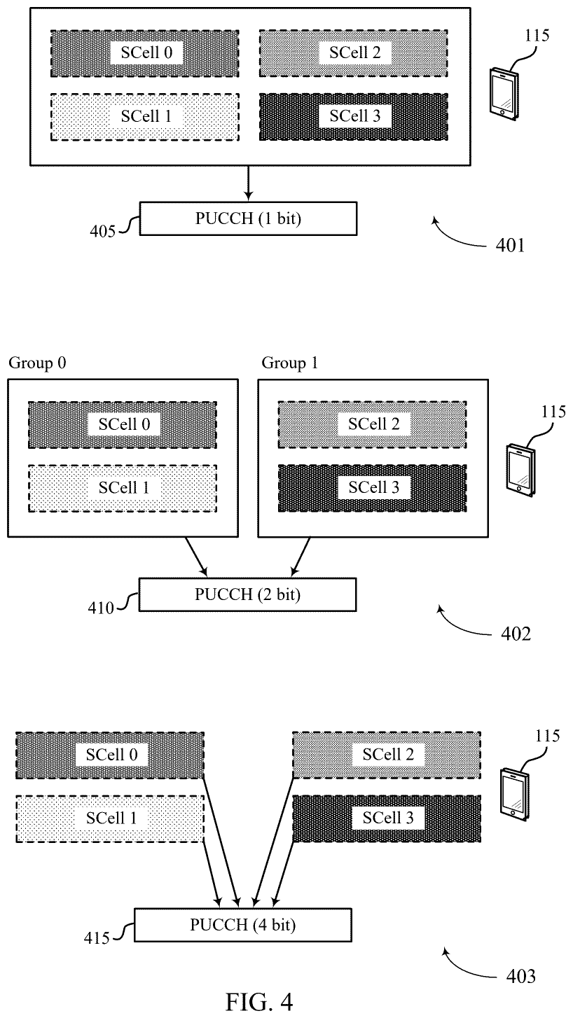

FIG. 4 shows example uplink resource reporting configurations 401, 402, and 403 that support secondary cell activation status reporting in accordance with one or more aspects of the present disclosure. For example, the uplink resource reporting configurations 401, 402, and 403 illustrate various implementations for a UE 115 to report a secondary cell activation status indication to indicate that CSI measurements are ready to be reported for one or more secondary cells configured for the UE 115. In some aspects, the UE 115 may be an example of a UE 115 described with reference to FIGS. 1-3.

The uplink resource reporting configuration 401 illustrates a quantity of secondary cells “SCells” (e.g., secondary cell 0, secondary cell 1, secondary cell 2, secondary cell 3, although a greater or lesser quantity of secondary cells are possible), which may be considered a group of secondary cells. The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit a 1 bit indicator in a PUCCH (e.g., a 1 bit PUCCH 405) which indicates the activation of each of the secondary cells (e.g., as a group common indication for the group of secondary cells). For example, a 1 bit PUCCH resource may be configured for all of the secondary cells (e.g., a 1 bit PUCCH resource representing activation of secondary cell 0, secondary cell 1, secondary cell 2, and secondary cell 3). The UE 115 may transmit the 1 bit PUCCH 405 to the network entity, and the network entity may transmit an aperiodic CSI reporting trigger requesting CSI reporting for all of the secondary cells based on the received 1 bit PUCCH.

The uplink resource reporting configuration 402 illustrates a quantity of secondary cells “SCells” (e.g., secondary cell 0, secondary cell 1, secondary cell 2, secondary cell 3, although a greater or lesser quantity of secondary cells are possible). In some examples, the secondary cells may be assigned to various different cell groups. For example, secondary cell 0 and secondary cell 1 may be assigned to a first secondary cell group (e.g., secondary cell group 0), and secondary cell 2 and secondary cell 3 may be assigned to a second secondary cell group (e.g., secondary cell group 1). In some aspects, the secondary cell groups may include equal quantities of secondary cells or different quantities of secondary cells. In some aspects, the groupings of the secondary cells may be implicitly derived by the UE 115 (e.g., secondary cells may be grouped together based on having the same operating frequency or being part of the same frequency band). Additionally, or alternatively, the UE 115 may receive explicit signaling from a network entity (e.g., control signaling, RRC signaling) that indicates different groupings for the secondary cells.

The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit a PUCCH indication that includes 1 bit per-cell group. For example, the UE 115 may transmit an M bit PUCCH to indicate activation of M groups of secondary cells, where each group of secondary cells contributes 1 bit to the M bit PUCCH. In the example of uplink resource reporting configuration 402, the UE 115 may transmit a 2 bit PUCCH 410 to indicate the activation of secondary cell group 0 and secondary cell group 1. In some examples, the UE 115 may transmit the M bit PUCCH when at least one secondary cell group is activated, when a threshold quantity of secondary cell groups are activated, or when all of the secondary cell groups are activated. In some implementations, if the UE 115 receives control signaling (e.g., RRC signaling) that initially configures the different secondary cell groups, the control signaling may also include cell group identifiers assigned to the different secondary cell groups, which may be used to map to bit position of the M bits in the secondary cell activation indication PUCCH.

The uplink resource reporting configuration 403 illustrates a quantity of secondary cells “SCells” (e.g., secondary cell 0, secondary cell 1, secondary cell 2, secondary cell 3, although a greater or lesser quantity of secondary cells are possible). The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit a per-cell indication (e.g., a 1 bit UCI configured for each secondary cell) using a N bit PUCCH resource that indicates the activation of up to N secondary cells. For example, for the activation of secondary cell 0, secondary cell 1, secondary cell 2, and secondary cell 3, the UE 115 may transmit a 4-bit PUCCH 415 indicating the activation of each of the secondary cells. In some examples, secondary cell indices may be used to associate a configured secondary cell with a corresponding bit position in the secondary cell activation status indicator.

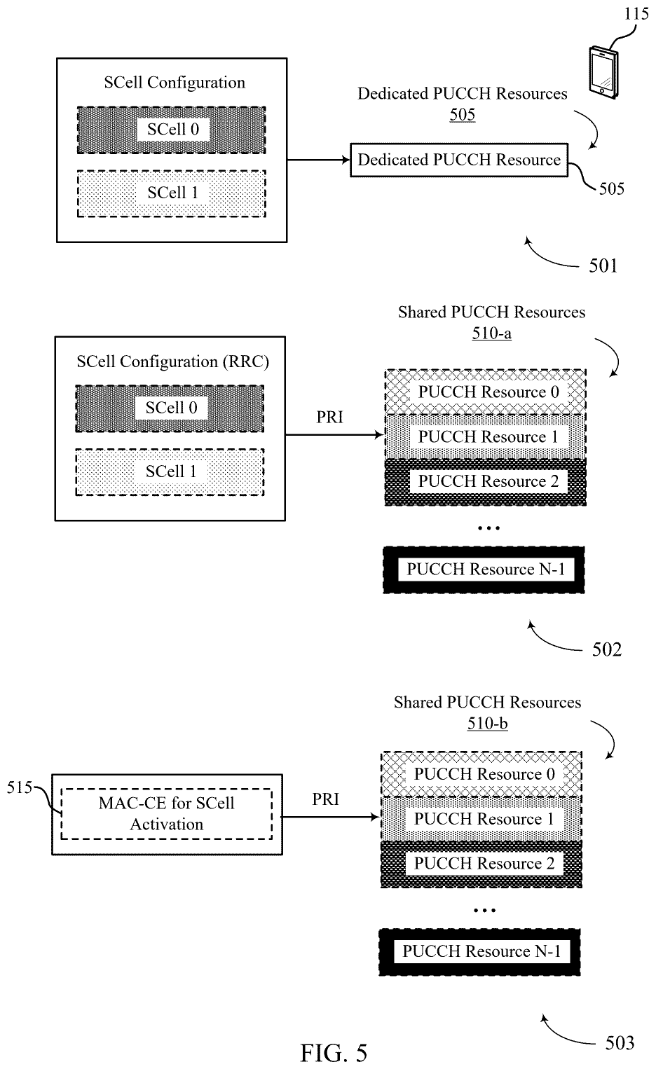

FIG. 5 shows example uplink resource reporting configurations 501, 502, and 503 that support secondary cell activation status reporting in accordance with one or more aspects of the present disclosure. For example, the uplink resource reporting configurations 501, 502, and 503 illustrate various implementations for a UE 115 to report a secondary cell activation status indication to indicate that CSI measurements are ready to be reported for one or more secondary cells configured for the UE 115. In some aspects, the UE 115 may be an example of a UE 115 described with reference to FIGS. 1-4.

The uplink resource reporting configuration 501 illustrates a quantity of secondary cells “SCells” (e.g., secondary cell 0 and secondary cell 1, although a greater or lesser quantity of secondary cells are possible). The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit the secondary cell activation status indicator using an uplink resource (e.g., a PUCCH resource) that is configured on the primary cell to indicate the secondary cell activation status. In some examples, the uplink resource may be a dedicated PUCCH resource 505 that may be configured separately from other PUCCH resources used for transmission of other UCI types. For example, the dedicated PUCCH resource 505 may be configured separately on the primary cell from resources used for transmission of HARQ, CSI, scheduling requests, or other types of UCI on the primary cell.

The uplink resource reporting configuration 502 illustrates a quantity of secondary cells “SCells” (e.g., secondary cell 0 and secondary cell 1, although a greater or lesser quantity of secondary cells are possible). The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit the secondary cell activation status indicator using an uplink resource (e.g., a PUCCH resource) on the primary cell to indicate the secondary cell activation status. In some examples, the uplink resource may be a part of a set of shared PUCCH resources 510-a (e.g., PUCCH resource 0, PUCCH resource 1, PUCCH resource 2, through PUCCH resource N−1) that may be configured for transmission of the secondary cell activation status indicator and for other UCI types (e.g., HARQ, CSI, scheduling requests, or other types of UCI) on the primary cell. In some examples, the UE 115 may receive RRC signaling that indicates a secondary cell configuration and also includes a PUCCH resource indicator (PRI) which indicates a specific PUCCH resource of the shared PUCCH resources 510-a that the UE 115 may use for transmission of the secondary cell activation status indicator.

The uplink resource reporting configuration 503 illustrates a resource selection configuration for selecting different PUCCH resources to use for transmission of the secondary cell activation status indicator. The UE 115 may perform a secondary cell activation procedure for the configured secondary cells, including performing downlink synchronization, CSI measurements, or both. In some examples, the UE 115 may transmit an indication to a network entity to notify the network entity that downlink synchronization, CSI measurement, or both, is completed for the secondary cells (e.g., the secondary cells are activated). In some such examples, the UE 115 may transmit the secondary cell activation status indicator using an uplink resource (e.g., a PUCCH resource) on the primary cell to indicate the secondary cell activation status. In some examples, the uplink resource may be a part of the shared PUCCH resources 510-b (e.g., PUCCH resource 0, PUCCH resource 1, PUCCH resource 2, through PUCCH resource N−1) that may be configured for transmission of the secondary cell activation status indicator and for other UCI types (e.g., HARQ, CSI, scheduling requests, or other types of UCI) on the primary cell. In some examples, the UE 115 may receive a MAC-CE 515 which activates the secondary cells and may also include the PRI which indicates the specific PUCCH resource of the shared PUCCH resources 510-b that the UE 115 may use for transmission of the secondary cell activation status indicator.

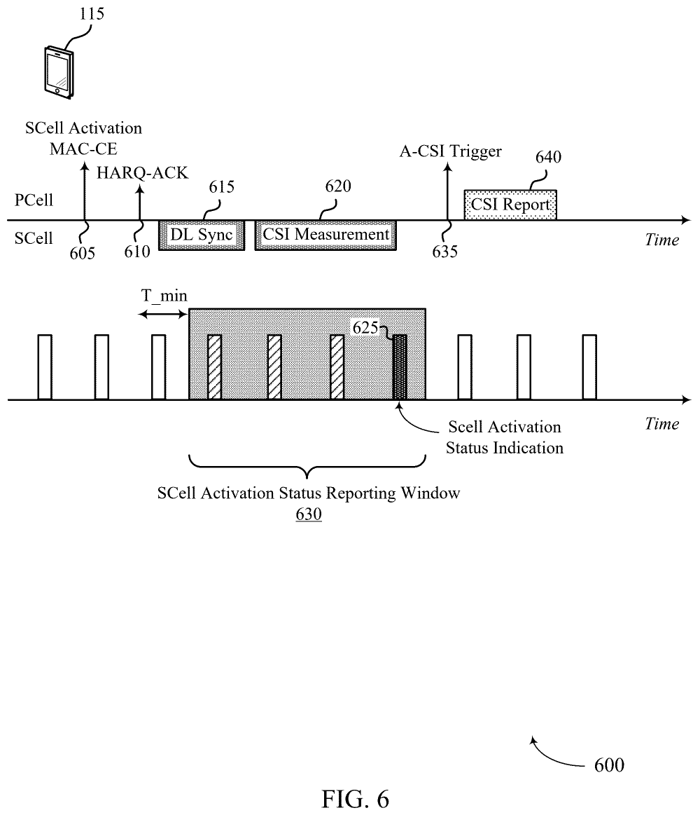

FIG. 6 shows an example of a secondary cell activation reporting timing diagram 600 that supports secondary cell activation status reporting in accordance with one or more aspects of the present disclosure. For example, the secondary cell activation reporting timing diagram 600 illustrates a timeline and various available resources for a UE 115 to report a secondary cell activation status indication to indicate that CSI measurements are ready to be reported for one or more secondary cells configured for the UE 115. In some aspects, the UE 115 may be an example of a UE 115 described with reference to FIGS. 1-5.

In some implementations, the UE 115 may utilize a PUCCH resource configuration to determine or select a resource to transmit a secondary cell activation status indication. During secondary cell activation, the UE 115 may receive a secondary cell activation MAC-CE 605, and may transmit HARQ-ACK feedback 610 responsive to the secondary cell activation MAC-CE 605. The UE 115 may then perform downlink synchronization 615 and CSI measurement 620. The UE 115 may then identify or select an uplink resource (e.g., a PUCCH resource) to transmit the secondary cell activation status indication. In some examples, the UE 115 may be configured with a time domain PUCCH resource configuration which indicates that PUCCH resources may be temporarily available for a secondary cell activation status reporting window 630 that begins after a threshold time (e.g., Tmin, which may start at a slot n where the UE 115 transmits the HARQ-ACK feedback 610 for the PDSCH carrying the secondary cell activation MAC-CE 605, and may extend for a minimum secondary cell activation delay), and ends at a time in which a network entity detects the secondary cell activation status indication and triggers aperiodic CSI reporting via the aperiodic CSI reporting trigger 635. In some examples, the UE 115 may select a PUCCH resource 625 within the secondary cell activation status reporting window 630 to use to report the secondary cell activation status indication. In some examples, the start of the time window may be associated with the length of Tmin, which may be a pre-configured value or a dynamically configured value (e.g., via RRC signaling for secondary cell configuration). After the UE 115 receives the aperiodic CSI reporting trigger 635, the UE 115 may transmit the CSI report 640 for the activated secondary cell.

In some examples, the PUCCH resources included within the secondary cell activation status reporting window 630 may be shared PUCCH resources or dedicated resources. In examples that the PUCCH resources are shared resources, the UE 115 may drop other PUCCH transmissions (e.g., UCI) on the same resource used to transmit the secondary cell activation status indication. In some other examples, the UE 115 may multiplex or concatenate other PUCCH transmissions (e.g., UCI) on the same resource used to transmit the secondary cell activation status indication within the secondary cell activation status reporting window 630. Thus, a network entity 105 may monitor for the secondary cell activation status indication during the secondary cell activation status reporting window 630 (e.g., over the shared PUCCH resources, multiplexed with other PUCCH transmissions).

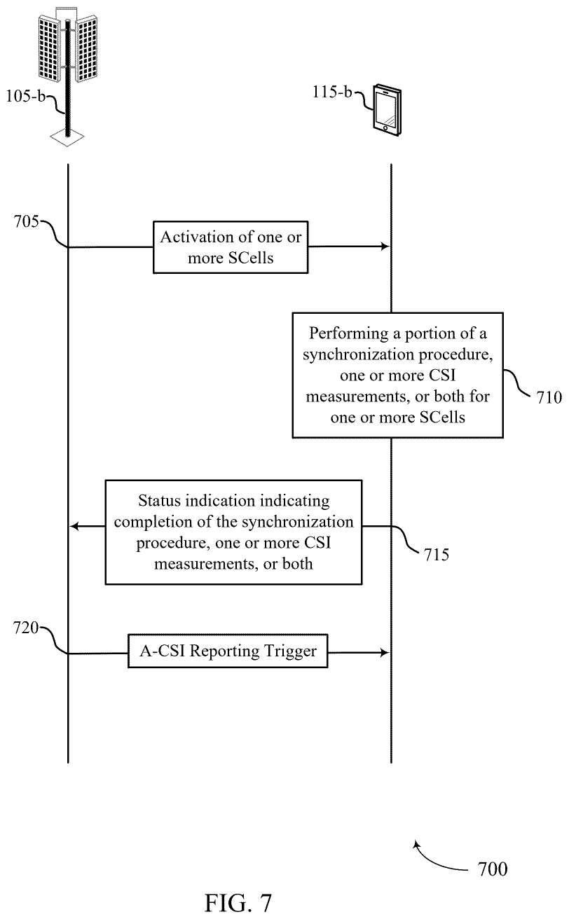

FIG. 7 shows an example of a process flow 700 that supports secondary cell activation status reporting in accordance with one or more aspects of the present disclosure. In some examples, process flow 700 may implement aspects of, or be implemented by aspects of, the wireless communications system 100 or the wireless communications system 200. In some examples, the process flow 700 may include a UE 115-b and a network entity 105-b which may be examples of corresponding devices described with reference to FIGS. 1-6.

In the following description of the process flow 700, the operations between the network entity 105-b and the UE 115-b may be performed in different orders or at different times than the example shown. Some operations may also be omitted from the process flow 700, and other operations may be added to the process flow 700. In this example, the network entity 105-b and the UE 115-b may support various techniques for secondary cell activation status reporting.

At 705 the UE 115-b may receive an indicator of an activation of one or more secondary cells configured for the UE 115-b.

At 710, the UE 115-b may perform at least one of a portion of a synchronization procedure (e.g., a downlink synchronization procedure), one or more CSI measurements, or both, for the one or more secondary cells in accordance with the activation of the one or more secondary cells. In some examples, the UE 115-b may monitor for periodic or aperiodic resources (e.g., CSI reference signals) for performing the one or more CSI measurements.

In some examples, the UE 115-b may receive control signaling that indicates a configuration of a set of periodic channel measurement resources, a set of periodic interference measurements resources, or both. The UE 115-b may then perform the synchronization procedure (e.g., the downlink synchronization procedure) and may perform, after performing the synchronization procedure, the one or more CSI measurements using a periodic channel measurement resource of the set of periodic channel measurement resources or a periodic interference measurement resource of the set of periodic interference measurement resources.

At 715, the UE 115-b may transmit, via a UCI, a status indication for the one or more secondary cells that indicates completion of the synchronization procedure, the one or more CSI measurements, or both.

In some examples, the UE 115-b may receive control signaling that indicates a configuration of the one or more secondary cells, a set of aperiodic or periodic channel measurement resources, a set of aperiodic or periodic interference measurement resources, or any combination thereof. The UE 115-b may then transmit the status indication subsequent to performing the synchronization procedure and prior to performing the one or more CSI measurements, or subsequent to performing both the synchronization procedure and the one or more CSI measurements, based at least in part on the control signaling (e.g., the UE 115-b may transmit the indication before or after performing CSI measurements based on configured CSI resources, secondary cell configuration, control signaling, or any combination thereof).

In some examples, the UCI message may include a single bit (e.g., a group-common indication) that indicates the completion of the synchronization procedure, the one or more CSI measurements, or both, for all of the one or more secondary cells (e.g., the single bit indicates that all of the configured secondary cells are ready for scheduling).

In some implementations, the one or more secondary cells include one or more secondary cell groups (where each secondary cell group includes at least one secondary cell, and each secondary cell group includes secondary cells that may be grouped based on a shared frequency band). The UE 115-b may then transmit the UCI message with a set of one or more bits that indicates completion of the synchronization procedure, the one or more CSI measurements, or both, for at least one secondary cell group of the one or more secondary cell groups. In such cases, each secondary cell group may correspond to a single bit of the set of one or more bits (e.g., the UE 115-b includes a respective bit for each respective secondary cell in the UCI message).

In some aspects, the UE 115-b may receive a control message that indicates respective cell group identifiers for the one or more secondary cells that correspond to a respective secondary cell group of the one or more secondary cell groups. In some examples, the respective cell group identifiers map to respective bits of the set of one or more bits of the UCI message (e.g., the respective cell group identifiers map to a bit position in the UCI message).

In some implementations, the UE 115-b may transmit, via the UCI message, a set of one or more bits that indicates completion of the synchronization procedure, the one or more CSI measurements, or both, for at least one secondary cell of the one or more secondary cells, such that each secondary cell corresponds to a single bit of the set of one or more bits included in the UCI message. In some aspects, the UE 115-b may receive a control message that indicates respective cell indices that correspond to respective secondary cells of the one or more secondary cells, and the respective cell indices map to respective bits of the one or more bits of the UCI message.

In some implementations, the UE 115-b may transmit the status indication via an uplink control channel resource that is dedicated for transmission of the UCI message conveying the status indication. In some implementations, the UE 115-b may transmit the status indication via an uplink control channel resource of a plurality of uplink control channel resources that are configured for either transmissions of the UCI message conveying the status indication or for other UCI messages. In some implementations, the UE 115-b may transmit the status indication as a singular transmission, or the UE 115-b may multiplex the status indication with other UCI (e.g., HARQ) in the UCI message.

In some examples, the UE 115-b may receive control signaling (e.g., via an RRC message that configures the one or more secondary cells or a MAC-CE that activates the one or more secondary cells) that includes an uplink control channel resource indicator (e.g., a PRI) that indicates the uplink control channel resource from multiple uplink control channel resources to use for transmission of the UCI message conveying the status indication.

At 720, the UE 115-b may receive a message that requests CSI reporting from the UE 115-b (e.g., an aperiodic CSI trigger) for the one or more secondary cells based on transmission of the status indication.

In some implementations, the UE 115-b may transmit the status indication via an uplink control channel resource of multiple uplink control channel resources that are valid for transmission of the status indication for a time window that spans a threshold duration. For example, the threshold duration may begin after a threshold secondary cell activation delay elapses and ends subsequent to receiving the message that requests the aperiodic CSI reporting. In some aspects, the UE 115-b may drop one or more other UCI messages that lack the status indication within the time window (e.g., and may transmit the status indication instead of transmitting the other UCI messages). Alternatively, the UE 115-b may multiplex the UCI message conveying the status indication with one or more other UCI messages on the uplink control channel resource.

In some examples, the UE 115-b may perform the one or more CSI measurements after performing the synchronization procedure and after transmission of the UCI message. For example, the UE 115-b may perform the one or more CSI measurements using an aperiodic channel measurement resource indicated by the message that requests the aperiodic CSI reporting, or using an aperiodic interference measurement resource indicated by the message that requests the aperiodic CSI reporting.

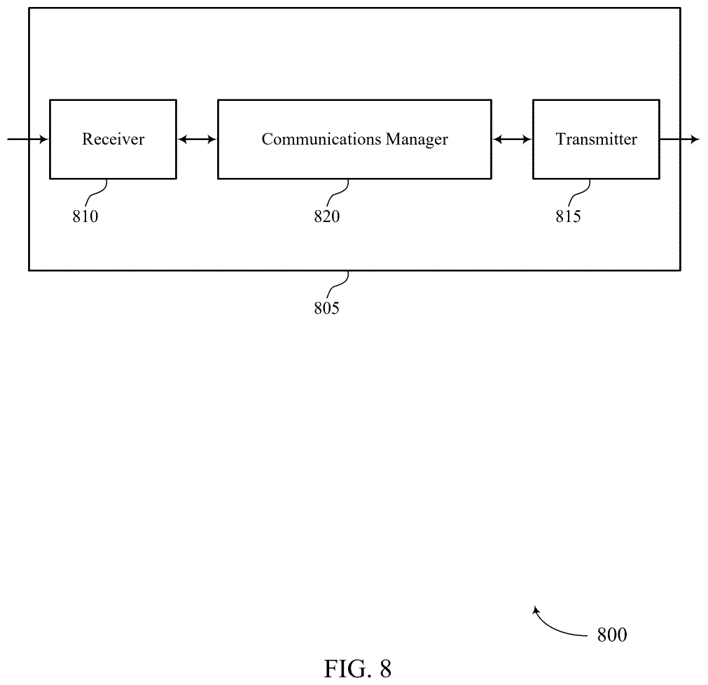

FIG. 8 shows a block diagram 800 of a device 805 that supports secondary cell activation status reporting in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to secondary cell activation status reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to secondary cell activation status reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of secondary cell activation status reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving an indicator of an activation of one or more secondary cells configured for the UE. The communications manager 820 is capable of, configured to, or operable to support a means for performing at least a portion of a synchronization procedure, one or more CSI measurements, or both, for the one or more secondary cells in accordance with the activation of the one or more secondary cells. The communications manager 820 is capable of, configured to, or operable to support a means for transmitting, via a UCI message, a status indication for the one or more secondary cells that indicates completion of the synchronization procedure, the one or more CSI measurements, or both. The communications manager 820 is capable of, configured to, or operable to support a means for receiving a message that requests aperiodic CSI reporting from the UE of the one or more secondary cells based on transmission of the status indication.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption, more efficient utilization of communication resources, improved device coordination, reduced communications latency.

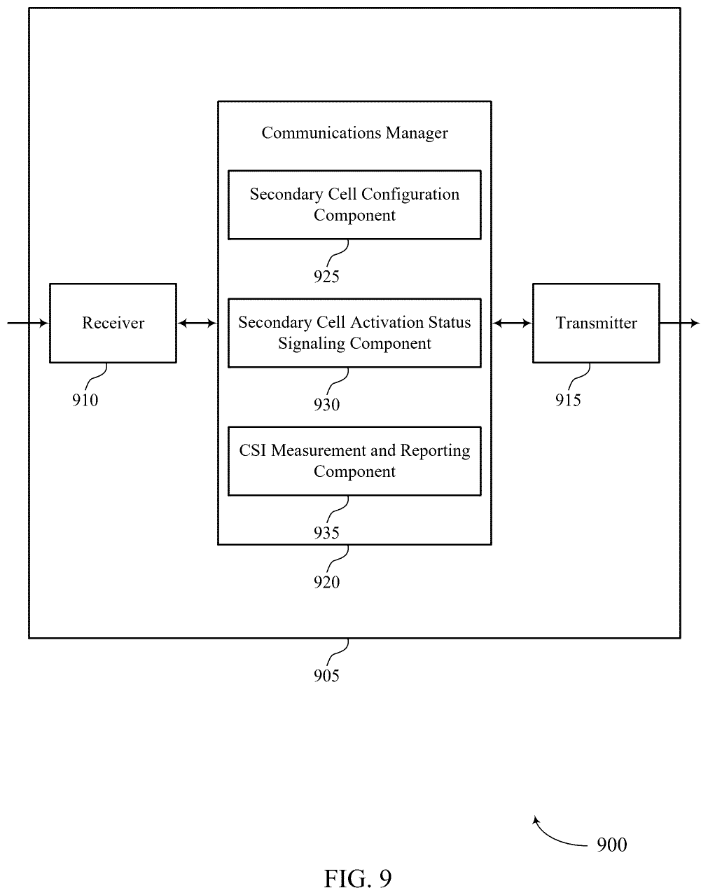

FIG. 9 shows a block diagram 900 of a device 905 that supports secondary cell activation status reporting in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to secondary cell activation status reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to secondary cell activation status reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of secondary cell activation status reporting as described herein. For example, the communications manager 920 may include a secondary cell configuration component 925, a secondary cell activation status signaling component 930, a CSI measurement and reporting component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The secondary cell configuration component 925 is capable of, configured to, or operable to support a means for receiving an indicator of an activation of one or more secondary cells configured for the UE. The secondary cell configuration component 925 is capable of, configured to, or operable to support a means for performing at least a portion of a synchronization procedure, one or more CSI measurements, or both, for the one or more secondary cells in accordance with the activation of the one or more secondary cells. The secondary cell activation status signaling component 930 is capable of, configured to, or operable to support a means for transmitting, via a UCI message, a status indication for the one or more secondary cells that indicates completion of the synchronization procedure, the one or more CSI measurements, or both. The CSI measurement and reporting component 935 is capable of, configured to, or operable to support a means for receiving a message that requests aperiodic CSI reporting from the UE of the one or more secondary cells based on transmission of the status indication.

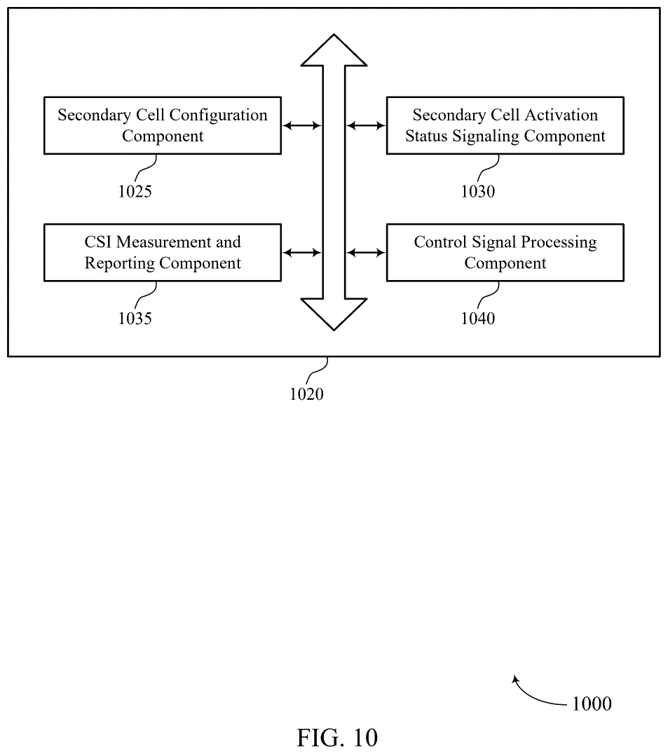

FIG. 10 shows a block diagram 1000 of a communications manager 1020 that supports secondary cell activation status reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of secondary cell activation status reporting as described herein. For example, the communications manager 1020 may include a secondary cell configuration component 1025, a secondary cell activation status signaling component 1030, a CSI measurement and reporting component 1035, a control signal processing component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The secondary cell configuration component 1025 is capable of, configured to, or operable to support a means for receiving an indicator of an activation of one or more secondary cells configured for the UE. In some examples, the secondary cell configuration component 1025 is capable of, configured to, or operable to support a means for performing at least a portion of a synchronization procedure, one or more CSI measurements, or both, for the one or more secondary cells in accordance with the activation of the one or more secondary cells. The secondary cell activation status signaling component 1030 is capable of, configured to, or operable to support a means for transmitting, via a UCI message, a status indication for the one or more secondary cells that indicates completion of the synchronization procedure, the one or more CSI measurements, or both. The CSI measurement and reporting component 1035 is capable of, configured to, or operable to support a means for receiving a message that requests aperiodic CSI reporting from the UE of the one or more secondary cells based on transmission of the status indication.

In some examples, the secondary cell configuration component 1025 is capable of, configured to, or operable to support a means for receiving control signaling indicative of a configuration of a set of periodic channel measurement resources, a set of periodic interference measurement resources, or both. In some examples, the secondary cell configuration component 1025 is capable of, configured to, or operable to support a means for performing the synchronization procedure. In some examples, the CSI measurement and reporting component 1035 is capable of, configured to, or operable to support a means for performing, subsequent to the completion of the synchronization procedure and prior to transmission of the UCI message, the one or more CSI measurements using a periodic channel measurement resource of the set of periodic channel measurement resources or a periodic interference measurement resource of the set of periodic interference measurement resources.

In some examples, to support performing at least the portion of the synchronization procedure, the one or more CSI measurements, or both, the secondary cell configuration component 1025 is capable of, configured to, or operable to support a means for performing the synchronization procedure. In some examples, to support performing at least the portion of the synchronization procedure, the one or more CSI measurements, or both, the CSI measurement and reporting component 1035 is capable of, configured to, or operable to support a means for performing, subsequent to the completion of the synchronization procedure and subsequent to transmission of the UCI message, the one or more CSI measurements using an aperiodic channel measurement resource indicated by the message that requests the aperiodic CSI reporting, or using an aperiodic interference measurement resource indicated by the message that requests the aperiodic CSI reporting.

In some examples, the secondary cell configuration component 1025 is capable of, configured to, or operable to support a means for receiving control signaling indicative of a configuration of the one or more secondary cells, a set of aperiodic or periodic channel measurement resources, a set of aperiodic or periodic interference measurement resources, or any combination thereof, where transmitting the status indication includes. In some examples, the secondary cell activation status signaling component 1030 is capable of, configured to, or operable to support a means for transmitting the status indication subsequent to the performing the synchronization procedure and prior to performing the one or more CSI measurements, or subsequent to performing both the synchronization procedure and the one or more CSI measurements, based on the control signaling.

In some examples, to support transmitting the status indication for the one or more secondary cells, the secondary cell activation status signaling component 1030 is capable of, configured to, or operable to support a means for transmitting, via the UCI message, a single bit that indicates completion of the synchronization procedure, the one or more CSI measurements, or both, for all of the one or more secondary cells. In some examples, the single bit includes a group common indication associated with the one or more secondary cells.

In some examples, to support transmitting the status indication for the one or more secondary cells, the secondary cell activation status signaling component 1030 is capable of, configured to, or operable to support a means for transmitting, via the UCI message, a set of one or more bits that indicates completion of the synchronization procedure, the one or more CSI measurements, or both, for at least one secondary cell group of the one or more secondary cell groups, where each secondary cell group corresponds to a single bit of the set of one or more bits.

In some examples, the control signal processing component 1040 is capable of, configured to, or operable to support a means for receiving a control message indicative of respective cell group identifiers for the one or more secondary cells that correspond to a respective secondary cell group of the one or more secondary cell groups, where the respective cell group identifiers map to respective bits of the set of one or more bits of the UCI message. In some examples, secondary cells operating on a same frequency band are included in a same secondary cell group of the one or more secondary cell groups.

In some examples, to support transmitting the status indication for the one or more secondary cells, the secondary cell activation status signaling component 1030 is capable of, configured to, or operable to support a means for transmitting, via the UCI message, a set of one or more bits that indicates completion of the synchronization procedure, the one or more CSI measurements, or both, for at least one secondary cell of the one or more secondary cells, where each secondary cell corresponds to a single bit of the set of one or more bits.

In some examples, the control signal processing component 1040 is capable of, configured to, or operable to support a means for receiving a control message indicative of respective cell indices that correspond to respective secondary cells of the one or more secondary cells, where the respective cell indices map to respective bits of the set of one or more bits of the UCI message.

In some examples, to support transmitting the status indication, the secondary cell activation status signaling component 1030 is capable of, configured to, or operable to support a means for transmitting the status indication via an uplink control channel resource that is dedicated for transmission of the UCI message conveying the status indication.

In some examples, to support transmitting the status indication, the secondary cell activation status signaling component 1030 is capable of, configured to, or operable to support a means for transmitting the status indication via an uplink control channel resource of a set of multiple uplink control channel resources that are configured for either transmissions of the UCI message conveying the status indication or for other UCI messages. In some examples, to support transmitting the status indication, the secondary cell activation status signaling component 1030 is capable of, configured to, or operable to support a means for multiplexing the status indication with other UCI in the UCI message.

In some examples, the control signal processing component 1040 is capable of, configured to, or operable to support a means for receiving control signaling including an uplink control channel resource indicator that indicates the uplink control channel resource from the set of multiple uplink control channel resources to use for transmission of the UCI message conveying the status indication. In some examples, the control signaling includes a radio resource control message that configures the one or more secondary cells or a medium access control-control element that activates the one or more secondary cells.

In some examples, to support transmitting the status indication, the secondary cell activation status signaling component 1030 is capable of, configured to, or operable to support a means for transmitting the status indication via an uplink control channel resource of a set of multiple uplink control channel resources that are valid for transmission of the status indication for a time window that spans a threshold duration. In some examples, the threshold duration begins after a threshold secondary cell activation delay elapses and ends subsequent to receiving the message that requests the aperiodic CSI reporting.

In some examples, to support transmitting the status indication, the secondary cell activation status signaling component 1030 is capable of, configured to, or operable to support a means for dropping one or more other UCI messages that lack the status indication within the time window. In some examples, to support transmitting the status indication, the secondary cell activation status signaling component 1030 is capable of, configured to, or operable to support a means for transmitting the UCI message conveying the status indication via the uplink control channel resource based on dropping the one or more other UCI messages.

In some examples, to support transmitting the status indication, the secondary cell activation status signaling component 1030 is capable of, configured to, or operable to support a means for multiplexing the UCI message conveying the status indication with one or more other UCI messages on the uplink control channel resource.

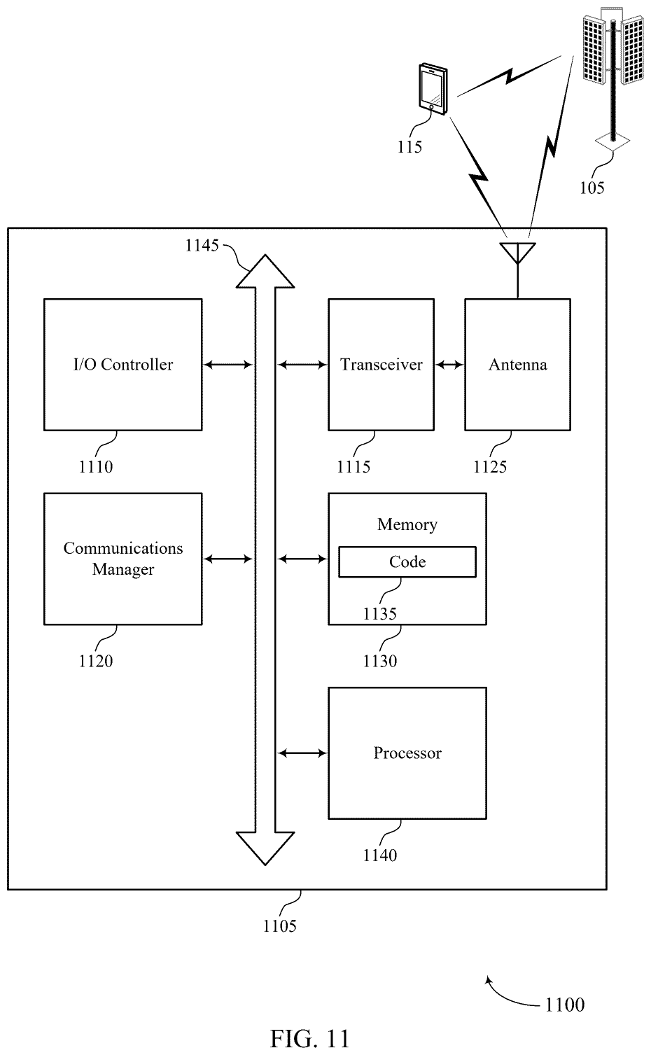

FIG. 11 shows a diagram of a system 1100 including a device 1105 that supports secondary cell activation status reporting in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting secondary cell activation status reporting). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving an indicator of an activation of one or more secondary cells configured for the UE. The communications manager 1120 is capable of, configured to, or operable to support a means for performing at least a portion of a synchronization procedure, one or more CSI measurements, or both, for the one or more secondary cells in accordance with the activation of the one or more secondary cells. The communications manager 1120 is capable of, configured to, or operable to support a means for transmitting, via a UCI message, a status indication for the one or more secondary cells that indicates completion of the synchronization procedure, the one or more CSI measurements, or both. The communications manager 1120 is capable of, configured to, or operable to support a means for receiving a message that requests aperiodic CSI reporting from the UE of the one or more secondary cells based on transmission of the status indication.

By including or configuring the communications manager 1120 in accordance with examples as described herein, the device 1105 may support techniques for improved communication reliability, reduced latency, improved user experience related to reduced latency, reduced power consumption, more efficient utilization of communication resources, improved coordination between devices, longer battery life, increased cellular coverage, increased throughput, and increased data rates.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of secondary cell activation status reporting as described herein, or the at least one processor 1140 and the at least one memory 1130 may be otherwise configured to, individually or collectively, perform or support such operations.

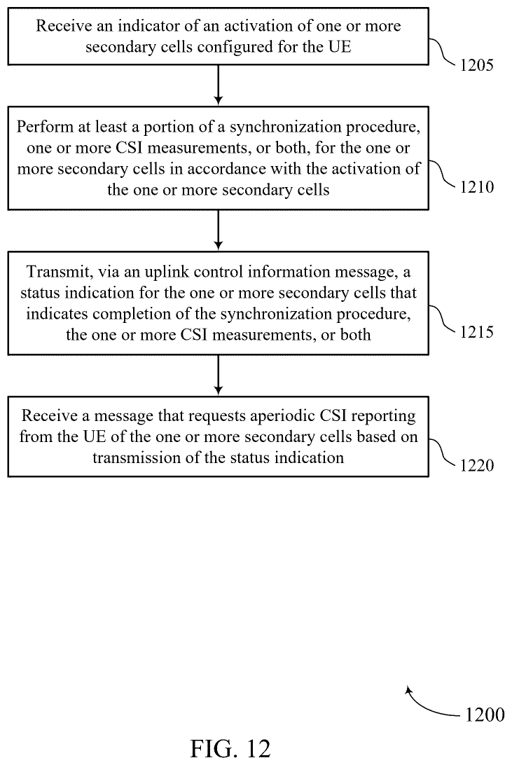

FIG. 12 shows a flowchart illustrating a method 1200 that supports secondary cell activation status reporting in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving an indicator of an activation of one or more secondary cells configured for the UE. The operations of 1205 may be performed in accordance with examples as disclosed herein and devices such as a UE 115 as described with reference to FIGS. 1 through 11. In some examples, aspects of the operations of 1205 may be performed by a secondary cell configuration component 1025 as described with reference to FIG. 10.

At 1210, the method may include performing at least a portion of a synchronization procedure, one or more CSI measurements, or both, for the one or more secondary cells in accordance with the activation of the one or more secondary cells. The operations of 1210 may be performed in accordance with examples as disclosed herein and devices such as a UE 115 as described with reference to FIGS. 1 through 11. In some examples, aspects of the operations of 1210 may be performed by a secondary cell configuration component 1025 as described with reference to FIG. 10.

At 1215, the method may include transmitting, via a UCI message, a status indication for the one or more secondary cells that indicates completion of the synchronization procedure, the one or more CSI measurements, or both. The operations of 1215 may be performed in accordance with examples as disclosed herein and devices such as a UE 115 as described with reference to FIGS. 1 through 11. In some examples, aspects of the operations of 1215 may be performed by a secondary cell activation status signaling component 1030 as described with reference to FIG. 10.

At 1220, the method may include receiving a message that requests aperiodic CSI reporting from the UE of the one or more secondary cells based on transmission of the status indication. The operations of 1220 may be performed in accordance with examples as disclosed herein and devices such as a UE 115 as described with reference to FIGS. 1 through 11. In some examples, aspects of the operations of 1220 may be performed by a CSI measurement and reporting component 1035 as described with reference to FIG. 10.

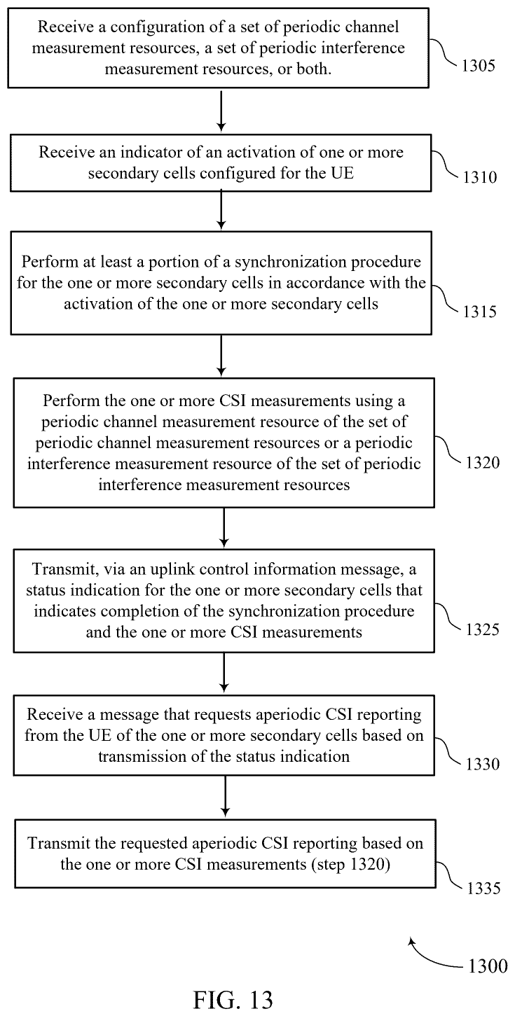

FIG. 13 shows a flowchart illustrating a method 1300 that supports secondary cell activation status reporting in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a configuration of a set of periodic channel measurement resources, a set of periodic interference measurement resources, or both. The operations of 1305 may be performed in accordance with examples as disclosed herein and devices such as a UE 115 as described with reference to FIGS. 1 through 11. In some examples, aspects of the operations of 1305 may be performed by a secondary cell configuration component 1025 as described with reference to FIG. 10.

At 1310, the method may include receiving an indicator of an activation of one or more secondary cells configured for the UE. The operations of 1310 may be performed in accordance with examples as disclosed herein and devices such as a UE 115 as described with reference to FIGS. 1 through 11. In some examples, aspects of the operations of 1310 may be performed by a secondary cell configuration component 1025 as described with reference to FIG. 10.

At 1315, the method may include performing at least a portion of a synchronization procedure in accordance with the activation of the one or more secondary cells. The operations of 1315 may be performed in accordance with examples as disclosed herein and devices such as a UE 115 as described with reference to FIGS. 1 through 11. In some examples, aspects of the operations of 1315 may be performed by a secondary cell configuration component 1025 as described with reference to FIG. 10.

At 1320, the method may include performing the one or more CSI measurements using a periodic channel measurement resource of the set of periodic channel measurement resources or a periodic interference measurement resource of the set of periodic interference measurement resources. The operations of 1320 may be performed in accordance with examples as disclosed herein and devices such as a UE 115 as described with reference to FIGS. 1 through 11. In some examples, aspects of the operations of 1320 may be performed by a CSI measurement and reporting component 1035 as described with reference to FIG. 10.

At 1325, the method may include transmitting, via a UCI message, a status indication for the one or more secondary cells that indicates completion of the synchronization procedure and the one or more CSI measurements. The operations of 1325 may be performed in accordance with examples as disclosed herein and devices such as a UE 115 as described with reference to FIGS. 1 through 11. In some examples, aspects of the operations of 1325 may be performed by a secondary cell activation status signaling component 1030 as described with reference to FIG. 10.

At 1330, the method may include receiving a message that requests aperiodic CSI reporting from the UE of the one or more secondary cells based on transmission of the status indication. The operations of 1330 may be performed in accordance with examples as disclosed herein and devices such as a UE 115 as described with reference to FIGS. 1 through 11. In some examples, aspects of the operations of 1330 may be performed by a CSI measurement and reporting component 1035 as described with reference to FIG. 10.

At 1335, the method may include transmitting the requested aperiodic CSI reporting based on the one or more CSI measurements performed with reference to 1320. The operations of 1335 may be performed in accordance with examples as disclosed herein and devices such as a UE 115 as described with reference to FIGS. 1 through 11. In some examples, aspects of the operations of 1335 may be performed by a CSI measurement and reporting component 1035 as described with reference to FIG. 10.

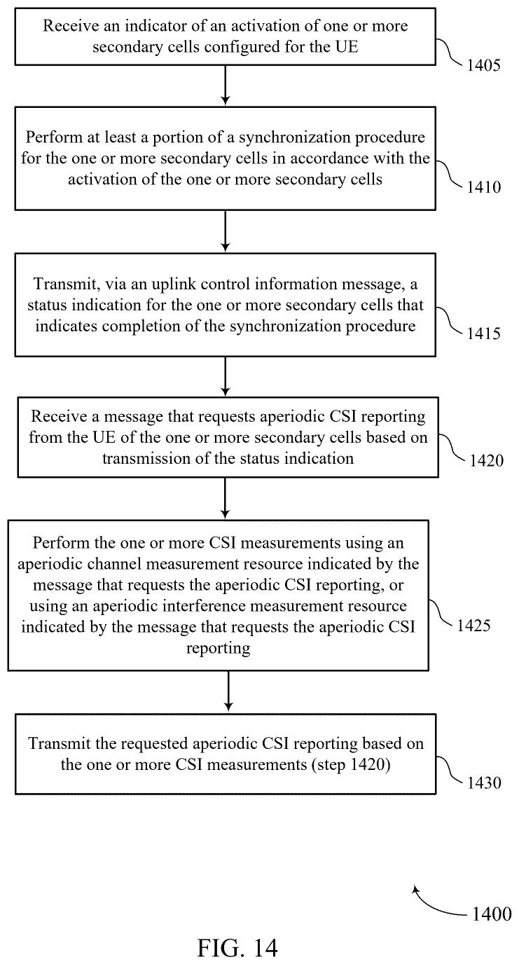

FIG. 14 shows a flowchart illustrating a method 1400 that supports secondary cell activation status reporting in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving an indicator of an activation of one or more secondary cells configured for the UE. The operations of 1405 may be performed in accordance with examples as disclosed herein and devices such as a UE 115 as described with reference to FIGS. 1 through 11. In some examples, aspects of the operations of 1405 may be performed by a secondary cell configuration component 1025 as described with reference to FIG. 10.

At 1410, the method may include performing at least a portion of a synchronization procedure for the one or more secondary cells in accordance with the activation of the one or more secondary cells. The operations of 1410 may be performed in accordance with examples as disclosed herein and devices such as a UE 115 as described with reference to FIGS. 1 through 11. In some examples, aspects of the operations of 1410 may be performed by a secondary cell configuration component 1025 as described with reference to FIG. 10.

At 1415, the method may include transmitting, via a UCI message, a status indication for the one or more secondary cells that indicates completion of the synchronization procedure. The operations of 1415 may be performed in accordance with examples as disclosed herein and devices such as a UE 115 as described with reference to FIGS. 1 through 11. In some examples, aspects of the operations of 1415 may be performed by a secondary cell activation status signaling component 1030 as described with reference to FIG. 10.

At 1420, the method may include receiving a message that requests aperiodic CSI reporting from the UE of the one or more secondary cells based on transmission of the status indication. The operations of 1420 may be performed in accordance with examples as disclosed herein and devices such as a UE 115 as described with reference to FIGS. 1 through 11. In some examples, aspects of the operations of 1420 may be performed by a CSI measurement and reporting component 1035 as described with reference to FIG. 10.

At 1425, the method may include performing the one or more CSI measurements using an aperiodic channel measurement resource indicated by the message that requests the aperiodic CSI reporting, or using an aperiodic interference measurement resource indicated by the message that requests the aperiodic CSI reporting. The operations of 1425 may be performed in accordance with examples as disclosed herein and devices such as a UE 115 as described with reference to FIGS. 1 through 11. In some examples, aspects of the operations of 1425 may be performed by a CSI measurement and reporting component 1035 as described with reference to FIG. 10.

At 1430, the method may include transmitting the requested aperiodic CSI reporting based on the one or more CSI measurements performed with reference to 1420. The operations of 1430 may be performed in accordance with examples as disclosed herein and devices such as a UE 115 as described with reference to FIGS. 1 through 11. In some examples, aspects of the operations of 1430 may be performed by a CSI measurement and reporting component 1035 as described with reference to FIG. 10.

The following provides an overview of aspects of the present disclosure:
Aspect 1: A method for wireless communications at a UE, comprising: receiving an indicator of an activation of one or more secondary cells configured for the UE; performing at least a portion of a synchronization procedure, one or more CSI measurements, or both, for the one or more secondary cells in accordance with the activation of the one or more secondary cells; transmitting, via a UCI message, a status indication for the one or more secondary cells that indicates completion of the synchronization procedure, the one or more CSI measurements, or both; and receiving a message that requests aperiodic CSI reporting from the UE of the one or more secondary cells based at least in part on transmission of the status indication.
Aspect 2: The method of aspect 1, further comprising: receiving control signaling indicative of a configuration of a set of periodic channel measurement resources, a set of periodic interference measurement resources, or both, wherein performing at least the portion of the synchronization procedure, the one or more CSI measurements, or both, comprises: performing the synchronization procedure; and performing, subsequent to the completion of the synchronization procedure and prior to transmission of the UCI message, the one or more CSI measurements using a periodic channel measurement resource of the set of periodic channel measurement resources or a periodic interference measurement resource of the set of periodic interference measurement resources.
Aspect 3: The method of any of aspects 1 through 2, wherein performing at least the portion of the synchronization procedure, the one or more CSI measurements, or both, comprises: performing the synchronization procedure; and performing, subsequent to the completion of the synchronization procedure and subsequent to transmission of the UCI message, the one or more CSI measurements using an aperiodic channel measurement resource indicated by the message that requests the aperiodic CSI reporting, or using an aperiodic interference measurement resource indicated by the message that requests the aperiodic CSI reporting.

Aspect 4: The method of any of aspects 1 through 3, further comprising: receiving control signaling indicative of a configuration of the one or more secondary cells, a set of aperiodic or periodic channel measurement resources, a set of aperiodic or periodic interference measurement resources, or any combination thereof, wherein transmitting the status indication comprises: transmitting the status indication subsequent to the performing the synchronization procedure and prior to performing the one or more CSI measurements, or subsequent to performing both the synchronization procedure and the one or more CSI measurements, based at least in part on the control signaling.
Aspect 5: The method of any of aspects 1 through 4, wherein transmitting the status indication for the one or more secondary cells comprises: transmitting, via the UCI message, a single bit that indicates completion of the synchronization procedure, the one or more CSI measurements, or both, for all of the one or more secondary cells.
Aspect 6: The method of aspect 5, wherein the single bit comprises a group common indication associated with the one or more secondary cells.
Aspect 7: The method of any of aspects 1 through 6, wherein the one or more secondary cells comprise one or more secondary cell groups including at least one secondary cell, wherein transmitting the status indication for the one or more secondary cells comprises: transmitting, via the UCI message, a set of one or more bits that indicates completion of the synchronization procedure, the one or more CSI measurements, or both, for at least one secondary cell group of the one or more secondary cell groups, wherein each secondary cell group corresponds to a single bit of the set of one or more bits.
Aspect 8: The method of aspect 7, further comprising: receiving a control message indicative of respective cell group identifiers for the one or more secondary cells that correspond to a respective secondary cell group of the one or more secondary cell groups, wherein the respective cell group identifiers map to respective bits of the set of one or more bits of the UCI message.
Aspect 9: The method of any of aspects 7 through 8, wherein secondary cells operating on a same frequency band are included in a same secondary cell group of the one or more secondary cell groups.
Aspect 10: The method of any of aspects 1 through 9, wherein transmitting the status indication for the one or more secondary cells comprises: transmitting, via the UCI message, a set of one or more bits that indicates completion of the synchronization procedure, the one or more CSI measurements, or both, for at least one secondary cell of the one or more secondary cells, wherein each secondary cell corresponds to a single bit of the set of one or more bits.
Aspect 11: The method of aspect 10, further comprising: receiving a control message indicative of respective cell indices that correspond to respective secondary cells of the one or more secondary cells, wherein the respective cell indices map to respective bits of the set of one or more bits of the UCI message.
Aspect 12: The method of any of aspects 1 through 11, wherein transmitting the status indication comprises: transmitting the status indication via an uplink control channel resource that is dedicated for transmission of the UCI message conveying the status indication.
Aspect 13: The method of any of aspects 1 through 12, wherein transmitting the status indication comprises: transmitting the status indication via an uplink control channel resource of a plurality of uplink control channel resources that are configured for either transmissions of the UCI message conveying the status indication or for other UCI messages.
Aspect 14: The method of aspect 13, wherein transmitting the status indication comprises: multiplexing the status indication with other UCI in the UCI message.
Aspect 15: The method of any of aspects 13 through 14, further comprising: receiving control signaling comprising an uplink control channel resource indicator that indicates the uplink control channel resource from the plurality of uplink control channel resources to use for transmission of the UCI message conveying the status indication.
Aspect 16: The method of aspect 15, wherein the control signaling comprises an RRC message that configures the one or more secondary cells or a MAC-CE that activates the one or more secondary cells.
Aspect 17: The method of any of aspects 1 through 16, wherein transmitting the status indication comprises: transmitting the status indication via an uplink control channel resource of a plurality of uplink control channel resources that are valid for transmission of the status indication for a time window that spans a threshold duration.
Aspect 18: The method of aspect 17, wherein the threshold duration begins after a threshold secondary cell activation delay elapses and ends subsequent to receiving the message that requests the aperiodic CSI reporting.
Aspect 19: The method of any of aspects 17 through 18, wherein transmitting the status indication comprises: dropping one or more other UCI messages that lack the status indication within the time window; and transmitting the UCI message conveying the status indication via the uplink control channel resource based at least in part on dropping the one or more other UCI messages.
Aspect 20: The method of any of aspects 17 through 19, wherein transmitting the status indication comprises: multiplexing the UCI message conveying the status indication with one or more other UCI messages on the uplink control channel resource.
Aspect 21: A UE for wireless communications, comprising one or more memories storing processor-executable code, and one or more processors coupled with the one or more memories and individually or collectively operable to execute the code to cause the UE to perform a method of any of aspects 1 through 20.
Aspect 22: A UE for wireless communications, comprising at least one means for performing a method of any of aspects 1 through 20.
Aspect 23: A non-transitory computer-readable medium storing code for wireless communications, the code comprising instructions executable by one or more processors to perform a method of any of aspects 1 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an indicator of an activation of one or more secondary cells configured for the UE;
perform at least a portion of a synchronization procedure, one or more channel state information (CSI) measurements, or both, for the one or more secondary cells in accordance with the activation of the one or more secondary cells;
transmit, via an uplink control information message, a status indication for the one or more secondary cells that indicates completion of the synchronization procedure, the one or more CSI measurements, or both; and
receive a message that requests aperiodic CSI reporting from the UE of the one or more secondary cells based at least in part on transmission of the status indication.

2. The UE of claim 1, wherein the one or more processors are individually or collectively further operable to execute the code to cause the UE to:
receive control signaling indicative of a configuration of a set of periodic channel measurement resources, a set of periodic interference measurement resources, or both, wherein performing at least the portion of the synchronization procedure, the one or more CSI measurements, or both, comprises:
perform the synchronization procedure; and
perform, subsequent to the completion of the synchronization procedure and prior to transmission of the uplink control information message, the one or more CSI measurements using a periodic channel measurement resource of the set of periodic channel measurement resources or a periodic interference measurement resource of the set of periodic interference measurement resources.

3. The UE of claim 1, wherein, to perform at least the portion of the synchronization procedure, the one or more CSI measurements, or both, the one or more processors are individually or collectively operable to execute the code to cause the UE to:
perform the synchronization procedure; and
perform, subsequent to the completion of the synchronization procedure and subsequent to transmission of the uplink control information message, the one or more CSI measurements using an aperiodic channel measurement resource indicated by the message that requests the aperiodic CSI reporting, or using an aperiodic interference measurement resource indicated by the message that requests the aperiodic CSI reporting.

4. The UE of claim 1, wherein the one or more processors are individually or collectively further operable to execute the code to cause the UE to:
receive control signaling indicative of a configuration of the one or more secondary cells, a set of aperiodic or periodic channel measurement resources, a set of aperiodic or periodic interference measurement resources, or any combination thereof, wherein transmitting the status indication comprises:
transmit the status indication subsequent to the performing the synchronization procedure and prior to performing the one or more CSI measurements, or subsequent to performing both the synchronization procedure and the one or more CSI measurements, based at least in part on the control signaling.

5. The UE of claim 1, wherein, to transmit the status indication for the one or more secondary cells, the one or more processors are individually or collectively operable to execute the code to cause the UE to:
transmit, via the uplink control information message, a single bit that indicates completion of the synchronization procedure, the one or more CSI measurements, or both, for all of the one or more secondary cells.

6. The UE of claim 5, wherein the single bit comprises a group common indication associated with the one or more secondary cells.

7. The UE of claim 1, wherein, to transmit the status indication for the one or more secondary cells, the one or more processors are individually or collectively operable to execute the code to cause the UE to:
transmit, via the uplink control information message, a set of one or more bits that indicates completion of the synchronization procedure, the one or more CSI measurements, or both, for at least one secondary cell group of one or more secondary cell groups, wherein each secondary cell group corresponds to a single bit of the set of one or more bits.

8. The UE of claim 7, wherein the one or more processors are individually or collectively further operable to execute the code to cause the UE to:
receive a control message indicative of respective cell group identifiers for the one or more secondary cells that correspond to a respective secondary cell group of the one or more secondary cell groups, wherein the respective cell group identifiers map to respective bits of the set of one or more bits of the uplink control information message.

9. The UE of claim 7, wherein secondary cells operating on a same frequency band are included in a same secondary cell group of the one or more secondary cell groups.

10. The UE of claim 1, wherein, to transmit the status indication for the one or more secondary cells, the one or more processors are individually or collectively operable to execute the code to cause the UE to:
transmit, via the uplink control information message, a set of one or more bits that indicates completion of the synchronization procedure, the one or more CSI measurements, or both, for at least one secondary cell of the one or more secondary cells, wherein each secondary cell corresponds to a single bit of the set of one or more bits.

11. The UE of claim 10, wherein the one or more processors are individually or collectively further operable to execute the code to cause the UE to:
receive a control message indicative of respective cell indices that correspond to respective secondary cells of the one or more secondary cells, wherein the respective cell indices map to respective bits of the set of one or more bits of the uplink control information message.

12. The UE of claim 1, wherein, to transmit the status indication, the one or more processors are individually or collectively operable to execute the code to cause the UE to:
transmit the status indication via an uplink control channel resource that is dedicated for transmission of the uplink control information message conveying the status indication.

13. The UE of claim 1, wherein, to transmit the status indication, the one or more processors are individually or collectively operable to execute the code to cause the UE to:
transmit the status indication via an uplink control channel resource of a plurality of uplink control channel resources that are configured for either transmissions of the uplink control information message conveying the status indication or for other uplink control information messages.

14. The UE of claim 13, wherein, to transmit the status indication, the one or more processors are individually or collectively operable to execute the code to cause the UE to:
multiplex the status indication with other uplink control information in the uplink control information message.

15. The UE of claim 13, wherein the one or more processors are individually or collectively further operable to execute the code to cause the UE to:
receive control signaling comprising an uplink control channel resource indicator that indicates the uplink control channel resource from the plurality of uplink control channel resources to use for transmission of the uplink control information message conveying the status indication, wherein the control signaling comprises a radio resource control message that configures the one or more secondary cells or a medium access control-control element that activates the one or more secondary cells.

16. The UE of claim 1, wherein, to transmit the status indication, the one or more processors are individually or collectively operable to execute the code to cause the UE to:
transmit the status indication via an uplink control channel resource of a plurality of uplink control channel resources that are valid for transmission of the status indication for a time window that spans a threshold duration, wherein the threshold duration begins after a threshold secondary cell activation delay elapses and ends subsequent to receiving the message that requests the aperiodic CSI reporting.

17. The UE of claim 16, wherein, to transmit the status indication, the one or more processors are individually or collectively operable to execute the code to cause the UE to:
drop one or more other uplink control information messages that lack the status indication within the time window; and
transmit the uplink control information message conveying the status indication via the uplink control channel resource based at least in part on dropping the one or more other uplink control information messages.

18. The UE of claim 16, wherein, to transmit the status indication, the one or more processors are individually or collectively operable to execute the code to cause the UE to:
multiplex the uplink control information message conveying the status indication with one or more other uplink control information messages on the uplink control channel resource.

19. A method for wireless communications at a user equipment (UE), comprising:
receiving an indicator of an activation of one or more secondary cells configured for the UE;
performing at least a portion of a synchronization procedure, one or more channel state information (CSI) measurements, or both, for the one or more secondary cells in accordance with the activation of the one or more secondary cells;
transmitting, via an uplink control information message, a status indication for the one or more secondary cells that indicates completion of the synchronization procedure, the one or more CSI measurements, or both; and
receiving a message that requests aperiodic CSI reporting from the UE of the one or more secondary cells based at least in part on transmission of the status indication.

20. A user equipment (UE) for wireless communications, comprising:
means for receiving an indicator of an activation of one or more secondary cells configured for the UE;
means for performing at least a portion of a synchronization procedure, one or more channel state information (CSI) measurements, or both, for the one or more secondary cells in accordance with the activation of the one or more secondary cells;
means for transmitting, via an uplink control information message, a status indication for the one or more secondary cells that indicates completion of the synchronization procedure, the one or more CSI measurements, or both; and
means for receiving a message that requests aperiodic CSI reporting from the UE of the one or more secondary cells based at least in part on transmission of the status indication.
